(19) United States
(12) Patent Application Publication
(10) Pub. No.: US 2005/0133966 A1
(43) Pub. Date: Jun. 23, 2005

(54) Method of heating golf ball components by radio frequency

(76) Inventors: Ajay P. Vora, Randolph, MA (US); David W. Sauerbrey, Marion, MA (US); Thomas L. Mydlack, Rochester, MA (US); Brian P. St. Aubin, South Dartmouth, MA (US)

Correspondence Address: ACUSHNET COMPANY, 333 BRIDGE STREET, P. O. BOX 965, FAIRHAVEN, MA, 02719, US

(21) Appl. No.: 11/062,969

(22) Filed: Feb. 23, 2005

Related U.S. Application Data
(63) Continuation of application No. 10/202,739, filed on Jul. 25, 2002.

(51) Int. Cl. B29C 39/10

(52) U.S. Cl. 264/491; 264/279.1; 264/297.8

(57) ABSTRACT

A method of heating a golf ball component by using radio frequency waves to reduce the thermal expansion experienced by a golf ball component such as a core, core and at least one core layer or a core and a combination of core and/or intermediate layers. The component is heated prior to having a layer applied in order to reduce the dramatic temperature increase the component experiences upon an intermediate layer being applied. The preheating reduces the amount of thermal expansion the component undergoes in the casting process.

### CROSS-REFERENCE TO RELATED APPLICATIONS

This application is continuation of co-pending U.S. application Ser. No. 10/202,739, which was filed Jul. 25, 2002, and is incorporated herein in its entirety by express reference thereto.

### FIELD OF THE INVENTION

The present invention relates generally to golf balls. More specifically, the present invention relates to methods for heating golf ball components.

### BACKGROUND OF THE INVENTION

Solid golf balls are usually two or more piece constructions. Two-piece golf balls include a single-piece core and a cover. The core forms a golf ball component that the cover surrounds. Multi-piece golf balls include one or more core layers, an intermediate layer, and a cover. In such balls, the core and intermediate layer form the golf ball component that the cover surrounds.

For a preferred cover, one material is a thermosetting composition. One method of making golf balls with a thermoset cover includes disposing the golf ball component into a cover mold and casting the cover thereon. During casting, heat is generated by an exothermic reaction of the thermoset processes. As a result of this heat, the ball component tends to undergo volumetric thermal expansion. The thermal expansion of the component can force the cover mold open and cause the component to shift in the mold so that the cover is uneven and has excessive flash. Also, the thermal expansion makes it difficult to maintain size accuracy in the finished ball. This can result in an unplayable ball.

Prior solid golf balls having cast urethane covers were made using a method that includes preheating the golf ball component to a predetermined elevated temperature. Preheating the component is done to the extent that causes the component to undergo volumetric thermal expansion. Thereafter, the cover is cast onto the component. For example, see U.S. Pat. No. 6,096,255, which is incorporated herein in its entirety.

It is well known in the art that preheating golf ball components decreases the total temperature change the component is exposed to and minimizes the thermal expansion of the component in the cover mold. Heating methods that have been utilized in the prior art are convection heating, whether it be a batch process or a continuous conveyor system. It is not unusual to require 34 hours of convection heating to raise the temperature of a golf ball core from 68° F. to 125° F. This length of time can be a production bottleneck and consume a large amount of energy.

Therefore, what is desired is a method of heating golf ball components by a much faster and energy efficient means.

### SUMMARY OF THE INVENTION

The invention provides a method for heating a golf ball component, whether it be a core, core having multiple core layers, or a core with additional intermediate layer(s) thereon. The heating is preferably completed prior to the component having a layer or cover applied. The method comprises heating the ball components by radio frequency (RF). The golf ball components travel into a RF field between a series of electrodes. The electrodes are located at the top and bottom of a conveyor system for a predetermined RF exposure. A RF generator provides the energy for pre-heating. Ball components pass through a RF applicator and RF attenuation tunnels at both the feed and discharge ends. Energy levels are controlled based on the load requirements calculated by specific heat and desired change in temperature. A custom automation system moves a high volume of product in and out of the RF tunnel for a desired length of time to heat the component to a predetermined temperature. One embodiment adds supplemental convection heating to enhance consistent temperature on the component surface.

Preferably, a tight temperature gradient is achieved across the cross-section of each ball component as well as a low deviation in temperature between each ball component.

An increase in energy efficiency is achieved as only that energy which directly heats the ball components is necessary and expended.

The present invention provides for a ball component exhibiting a greater consistency as RF heats the product from the center to the outside.

An embodiment of the invention provides for a post cure of a polybutadiene core to reduce the time of the molding cycle.

The present invention provides for a rapid curing of urethane golf ball covers.

The present invention provides for pre-heating the golf ball prior to spray painting and for providing RF heat to cure the paint.

### BRIEF DESCRIPTION OF THE DRAWINGS

FIG. 1 is an elevational partially cut-out front view of a conveyor feed of product into and out of an RF heater.

FIG. 2 is a top view of the system shown in FIG. 1.

### DESCRIPTION OF THE PREFERRED EMBODIMENTS

The present invention relates generally to the heating of golf ball components by radio frequency (RF). The components can include a core, a center and at least one core layer, or a core, and a combination of at least one core layer and/or at least one intermediate layer. RF heating can also be employed to post-cure golf ball polybutadiene cores, cure urethane castings and cure the spray paint on a finished golf ball. The golf balls may also be pre-heated by RF waves prior to the application of the paint.

A golf ball component experiences a dramatic increase of heat when a core layer or especially an intermediate layer or cover layer is cast to it. The volumetric expansion of the ball component during this process often causes manufacturing difficulties. One problem area is that the thermal expansion of the component can force the cover mold open and cause the component to shift in the mold so that the cover is uneven and has excessive flash. This can result in an unplayable ball. To alleviate and counteract excessive thermal expansion during the casting process, manufacturers may preheat the ball component to a predetermined elevated temperature, usually between about 100° F. to about 160° F. and up to 300° F. when used for post curing of polybutadiene cores. The pre-heated ball component is therefore not exposed to the dramatic volumetric thermal expansion as would an unheated component. It is well known in the art that preheating the golf ball components decreases total temperature change the component is exposed to and therein minimizes the thermal expansion of the component while in the cover mold. Thus, manufacturers may preheat the golf ball components prior to casting over them with another layer. Methods that have been utilized in the prior art are primarily two types of convection heating; a batch process and a continuous conveyor process. It is not unusual with the batch process to require about 3-4 hours of convection heating to raise the temperature of a golf ball core from 68° F. to 125° F. In a continuous conveyor process this time can be reduced to about 45 to 60 minutes. This length of time can be a production bottleneck in both space and energy costs.

The present invention utilizes a method of heating the golf ball component by means of radio frequency (RF) waves. This as accomplished by feeding golf ball components into the system by automatic conveyor feed system and subsequently into an RF generated field, where the temperature rise in a golf ball component from about 68° F. to 125° F. can be achieved in 30 to 60 seconds. (Chart I below) It is to be appreciated that while the method as described herein utilizes a conveyor feed system, the present invention may also be employed utilizing a batch process.

COMPARISON OF GOLF BALL SUBASSEMBLY PRE-HEATING METHODS

| | INITIAL CORE TEMP. | FINAL CORE TEMP. | TEMPERATURE RISE | |
|---|---|---|---|---|
| | (PRIOR TO HEATING) | (AFTER HEATING) | (Δ T) | PROCESS TIME |
| HEATING METHOD | (DEG. F.) | (DEG. F.) | (DEG. F.) | (HRS: MINS; SECS;) |
| CONVECTION HEAT | 68 | 125 | 57 | 3-4 HRS. |
| BATCH PROCESS | | | | |
| CONVECTION HEAT | 68 | 125 | 57 | 45-60 MINS. |
| CONTINUOUS | | | | |
| CONVEYOR | | | | |
| RADIO FREQUENCY | 68 | 125 | 57 | 30-60 SECS. |
| CONTINUOUS | | | | |
| CONVEYOR | | | | |

The present invention provides for a product with a greater consistency as RF waves heat the golf ball component from the center to the outside. The heating occurs instantly and uniformly throughout all three dimensions. No temperature differential is required to force heat by conduction from the surface to the center as in surface heating processes. An increase in energy efficiency is achieved as only energy is used that directly heats the product. No long warm-up or cooling time is required. Power is consumed only when the load is present and only in proportion to the load.

In a radio frequency heating system, the RF generator creates an alternating electric field between two electrodes. The component to be heated is conveyed between the electrodes where the alternating energy caused polar molecules in the product material to continuously reorient themselves to face opposite poles much like the way bar magnets behave in an alternating magnetic field. The friction resulting from molecular movement causes the material to rapidly heat throughout its entire mass. The amount of heat generated in the component is determined by the frequency, the square of the applied voltage, dimensions of the component and the dielectric loss factor of the material which is essentially a measure of the ease with which the material can be heated by RF waves.

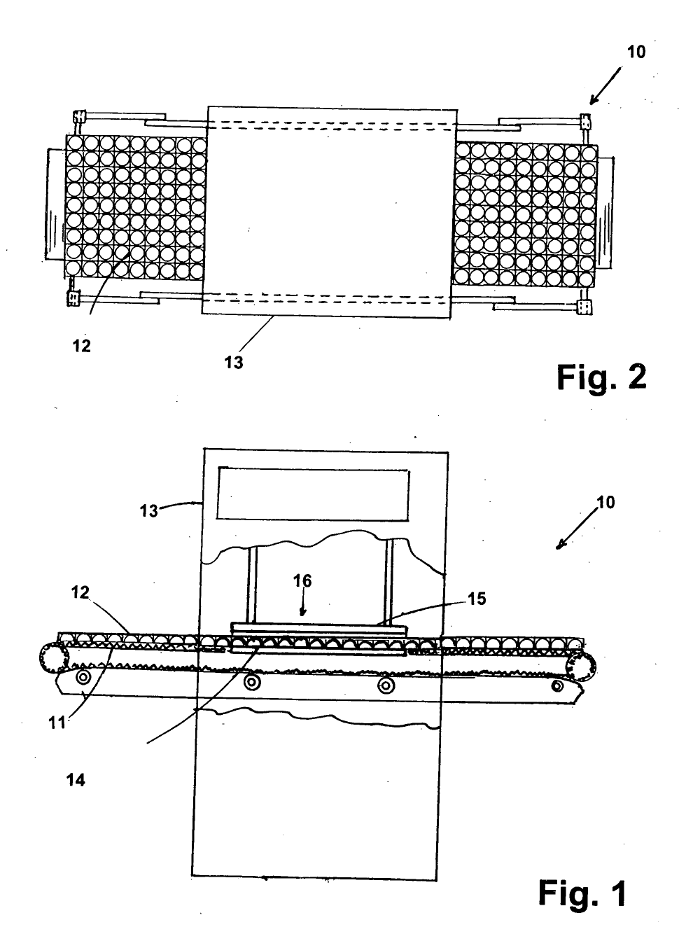

The process of the present invention is shown on FIGS. 1 and 2. A continuous conveyor 11 accepts a continuous supply of golf ball components 12 and transports them into and through a RF generator 13 where a pair of electrodes, a ground electrode 14 and a plate electrode 15, create a RF field 16 therebetween. The golf ball components 12 are passed through the RF field 16 by a custom automation system at such a rate to cause an increase in golf ball temperature from room temperature (about 68° F.) to about 100° F. to 160° F. The rate of speed in which the golf ball components 12 are moved within the RF waves is a function of the energy that is required to raise the temperature of the components to the predetermined temperature. The time is preferably between 30 to 60 seconds. Energy levels are controlled based on the load requirements calculated by specific heat and desired temperature change. The time is a function of the energy level capacity of the machine 10 and the number, size and composition of the components 12 moving through the field 16 at any given time. The present invention employs a conveyor feed system that handles rows of multiple golf ball components. As the components pass through the field 16, the conveyor has means to constantly rotate them, thereby allowing for a more uniform heating of each component. Although the drawings show rows having 9 components across, this number is merely a convenience item that relates directly to the size of each component and the RF equipment. Preferably the number of ball components in a row is greater than 3 and between 6 to 12.

In another embodiment of the invention, supplemental convection heating is added to enhance a consistent temperature across the surface of the component.

The definition of a golf ball component 12 includes a single layer core; a core of a center and at least one outer core layer; and a core of one or more layers covered by at least one intermediate layer. The method of the present invention is intended to heat the golf ball component 12 prior to casting a subsequent core, intermediate layer or cover layer thereon, and if further core or intermediate layers are desired they are preferably subsequently cast prior to the ball component cooling down.

The type of preheating equipment used to generate the RF waves is preferably a Macrowave™ Model L-200 such as supplied by the Radio Frequency Company, Millis, Mass.

The core composition can be made from any suitable core materials including thermoset polymers, such as natural rubber, ethylene propylene rubber or epdiene monomer, polybutadiene (PBD), polyisoprene, styrene-butadiene or styrene-propylene-diene rubber, and thermoplastics such as ionomer resins, polyamides, polyesters, or a thermoplastic elastomer. Suitable thermoplastic elastomers include Pebax®, which is believed to comprise polyether amide copolymers, Hytrel®, which is believed to comprise polyether ester from Elf-Atochem, E.I. Du Pont de Nemours and Company, various manufacturers, and Shell Chemical Company, respectively. The core materials can also be formed from a castable material. Suitable castable materials include those comprising a urethane, polyurea, epoxy, silicone, IPN's, etc.

The polybutadiene rubber composition preferably includes between about 2.2 parts and about 5 parts of a halogenated organosulfur compound. The halogenated conventional materials for such cores include core compositions having a base rubber, a cross-linking agent, filler and a co-cross-linking agent. The base rubber typically includes natural or synthetic rubbers. A preferred base rubber is 1,4-polybutadiene having a cis-structure of at least 40%. Natural rubber, polyisoprene rubber and/or styrene-butadiene rubber may be optionally added to the 1,4-polybutadiene. The initiator included in the core composition can be any known polymerization initiator that decomposes during the cure cycle. The cross-linking agent includes a metal salt of an unsaturated fatty acid such as a zinc salt or a magnesium salt of an unsaturated fatty acid having 3 to 8 carbon atoms such as acrylic or methacrylic acid. The filler typically includes materials such as tungsten, zinc oxide, barium sulfate, silica, calcium carbonate, zinc carbonate and the like. The polybutadiene rubber composition preferably includes between about 2.2 parts and about 5 parts of a halogenated organosulfur compound. The halogenated organo-sulfur compound may include pentafluorothiophenol; 2-fluorothiophenol; 3-fluorothiophenol; 4-fluorothiophenol; 2,3-fluorothiophenol; 2,4-fluorothiophenol; 3,4-fluorothiophenol; 3,5-fluorothiophenol 2,3,4-fluorothiophenol; 3,4,5-fluorothiophenol; 2,3,4,5-tetrafluorothiophenol; 2,3,5,6-tetrafluorothiophenol; 4-chlorotetrafluorothiophenol; pentachlorothiophenol; 2-chlorothiophenol; 3-chlorothiophenol; 4-chlorothiophenol; 2,3-chlorothiophenol; 2,4-chlorothiophenol; 3,4-chlorothiophenol; 3,5-chlorothiophenol; 2,3,4-chlorothiophenol; 3,4,5-chlorothiophenol; 2,3,4,5-tetrachlorothiophenol; 2,3,5,6-tetrachlorothiophenol; tetrafluorothiophenol; 4-chlorotetrafluorothiophenol; pentachlorothiophenol; 2-chlorothiophenol; 3-chlorothiophenol; 4-chlorothiophenol; 2,3-chlorothiophenol; 2,4-chlorothiophenol; 3,4-chlorothiophenol; 3,5-chlorothiophenol; 2,3,4-chlorothiophenol; 3,4,5-chlorothiophenol; 2,3,4,5-tetrachlorothiophenol; 2,3,5,6-tetrachlorothiophenol; pentabromothiophenol; 2-bromothiophenol; 3-bromothiophenol; 4-bromothiophenol; 2,3-bromothiophenol; 2,4-bromothiophenol; 3,4-bromothiophenol; 3,5-bromothiophenol; 2,3,4-bromothiophenol; 3,4,5-bromothiophenol; 2,3,4,5-tetrabromothiophenol; 2,3,5,6-tetrabromothiophenol; pentaiodothiophenol; 2-iodothiophenol; 3-iodothiophenol; 4-iodothiophenol; 2,3-iodothiophenol; 2,4-iodothiophenol; 3,4-iodothiophenol; 3,5-iodothiophenol; 2,3,4-iodothiophenol; 3,4,5-iodothiophenol; 2,3,4,5-tetraiodothiophenol; 2,3,5,6-tetraiodothiophenoland; and their zinc salts, the metal salts thereof, and mixtures thereof, but is preferably pentachlorothiophenol or the metal salt thereof. The metal salt may be zinc, calcium, potassium, magnesium, sodium, and lithium, but is preferably zinc.

Additionally, suitable core materials may also include cast or reaction injection molded polyurethane or polyurea, including those versions referred to as nucleated, where a gas, typically nitrogen, is incorporated via intensive agitation or mixing into at least one component of the polyurethane. (Typically, the pre-polymer, prior to component injection into a closed mold where essentially full reaction takes place resulting in a cured polymer having reduced specific gravity.) These materials are referred to as reaction injection molded (RIM) materials. Alternatively, the core may have a liquid center.

The core preferably has a compression in the range between about 30 to 110. For a core that is relaively soft the compression should be about 40 to 80, and for a relatively hard core, the compression should be about 90 to 110. The core preferably has a Coefficient of Restitution greater than 0.80.

The intermediate layer, if desired, can be formed by joining two hemispherical cups of material in a compression mold or by injection molding, as known by one of ordinary skill in the art. The intermediate layer may be a thermoplastic or a thermoset material. For example, a recommended ionomer resin material is SURLYN® and a recommended thermoplastic copolyetherester is Hytrel®, which are commercially available from DuPont. Blends of these materials can also be used. Another example of a suitable intermediate layer material is a thermoplastic elastomer, such as described in U.S. Pat. Nos. 6,315,680 and 5,688,191, which are both incorporated herein by reference in their entireties.

The intermediate layer may be formulated wherein vulcanized PP/EPDM. Santoprene® 203-40 is an example of a preferred intermediate layer comprises of dynamically vulcanized thermoplastic elastomer, functionalized styrene-butadiene elastomer, thermoplastic polyurethane or metallocene polymer or blends thereof. Suitable dynamically vulcanized thermoplastic elastomers include Santoprene®, Sarlink®, Vyram®, Dytron® and Vistaflex®. Santoprene® is the trademark for a dynamically Santoprene® and is commercially available from Advanced Elastomer Systems. Examples of suitable functionalized styrene-butadiene elastomers include Kraton FG-1901× and FG-1921×, which is available from the Shell Corporation. Examples of suitable thermoplastic polyurethanes include Estane® 58133, Estane® 58134 and Estane® 58144, which are commercially available from the B. F. Goodrich Company. Suitable metallocene polymers whose melting points are higher than the cover materials can also be employed in the mantle layer of the present invention. Further, the materials for the intermediate layer described above may be in the form of a foamed polymeric material. For example, suitable metallocene polymers include foams of thermoplastic elastomers based on metallocene single-site catalyst-based foams. Such metallocene-based foam resins are commercially available from Sentinel Products of Hyannis, Mass. Suitable thermoplastic polyetheresters include Hytrel® 3078, Hytrel® 3548, Hytrel® 4078, Hytrel® 4069, Hytrel® 6356, Hytrel® 7246, and Hytrel® 8238 which are commercially available from DuPont. Suitable thermoplastic polyetheramides include Pebax® 2533, Pebax® 3533, Pebax® 4033, Pebax® 5533, Pebax® 6333, and Pebax® 7033 which are available from Elf-Atochem. Suitable thermoplastic ionomer resins include any number of olefinic based ionomers including SURLYN® and lotek®, which are commercially available from DuPont and Exxon, respectively. The flexural moduli for these ionomers is about 1000 psi to about 200,000 psi. Suitable thermoplastic polyesters include polybutylene terephthalate. Likewise, the dynamically vulcanized thermoplastic elastomers, functionalized styrene-butadiene elastomers, thermoplastic polyurethane or metallocene polymers identified above are also useful as the second thermoplastic in such blends. Further, the materials of the second thermoplastic described above may be in the form of a foamed polymeric material.

Such thermoplastic blends comprise about 1% to about 99% by weight of a first thermoplastic and about 99% to about 1% by weight of a second thermoplastic. Preferably the thermoplastic blend comprises about 5% to about 95% by weight of a first thermoplastic and about 5% to about 95% by weight of a second thermoplastic. In a preferred embodiment of the present invention, the first thermoplastic material of the blend is a thermoplastic polyetherester, such as Hytrel®.

The present invention includes urethane/polyurea intermediate layer having a Shore D hardness less than 60, and for a soft layer a Shore D of less than 50, and a flexural modulus between 500 and 30,000 psi.

The present invention also includes the use of a variety of non-conventional cover materials. In particular, the covers of the present invention may comprise thermoplastic or engineering plastics such as ethylene or propylene based homopolymers and copolymers including functional monomers such as acrylic and methacrylic acid and fully or partially neutralized ionomers and their blends, methyl acrylate, methyl methacrylate homopolymers and copolymers, imidized, amino group containing polymers, polycarbonate, reinforced polyamides, polyphenylene oxide, high impact polystyrene, polyether ketone, polysulfone, poly(phenylene sulfide), reinforced engineering plastics, acrylonitrile-butadiene, acrylic-styrene-acrylonitrile, poly(ethylene terephthalate), poly(butylene terephthalate), poly(ethylene-vinyl alcohol), poly(tetrafluoroethylene) and their copolymers including functional comonomers and blends thereof. These polymers or copolymers can be further reinforced by blending with a wide range of fillers and glass fibers or spheres or wood pulp.

Additional preferred cover materials include thermoplastic or thermosetting polyurethane, such as those disclosed in U.S. Pat. Nos. 6,371,870; 6,210,294; 6,193,619; and 5,484,870; and metallocene or other single site catalyzed polymers such as those disclosed in U.S. Pat. Nos. 5,824,746; and 5,981,658.

While it is apparent that the illustrative embodiments of the invention disclosed herein fulfill the objectives stated above, it is appreciated that numerous modifications and other embodiments may be devised by those skilled in the art. Therefore, it will be understood that the appended claims are intended to cover all such modifications and embodiments which would come within the spirit and scope of the present invention.

1. A method of forming golf balls, comprising the steps of:
providing a plurality of golf ball components in rows of 6-12 on an automatic conveyor;
providing a radio frequency wave field;
passing the components on the conveyor through the radio frequency field for a time period of about 30 to 60 seconds to achieve a predetermined temperature increase of the components without altering the shape or size of the components;
constantly rotating the golf ball components through the radio frequency wave field;
removing the components from the radio frequency wave field; and
casting cover layers over the components.

2. The method according to claim 1, wherein the method further comprises providing a flow of supplemental convection heating prior to removing the components from the radio frequency field for enhancing a uniform surface temperature.

3. The method according to claim 1, wherein the component is heated from about 100° F. to about 160° F.
